(19) United States
(12) Patent Application Publication
(10) Pub. No.: US 2011/0108484 A1
(43) Pub. Date: May 12, 2011

(54) METHOD OF IMPROVING PERFORMANCE OF A REVERSE OSMOSIS SYSTEM FOR SEAWATER DESALINATION, AND MODIFIED REVERSE OSMOSIS SYSTEM OBTAINED THEREBY

(75) Inventors: Boris Liberman, Tel-Aviv (IL); David Hefer, Haifa (IL); Maya Ile-Vicky-Ozel, Tel-Aviv (IL); Miriam Faigon, Kfar Saba (IL)

(73) Assignee: I.D.E. TECHNOLOGIES LTD., Kadima (IL)

(21) Appl. No.: 13/003,001

(22) PCT Filed: May 19, 2009
(86) PCT No.: PCT/IL09/00495

§ 371 Date: Jan. 7, 2011

(30) Foreign Application Priority Data
Jul. 9, 2008 (US) 61/129652

(51) Int. Cl. B01D 61/06; C02F 1/44

(52) U.S. Cl. 210/652; 210/170.11

(57) ABSTRACT

A method for improving performance of an original reverse osmosis system for seawater desalination, the original system comprising a high pressure pump, a reverse osmosis membrane arrangement, a pump hydraulic line and a turbine hydraulic line, the method comprising operating the motor at a power lower than a normal operation power; providing an energy recovery device; splitting new brine flow to a first brine flow; supplying an additional seawater; providing a booster pump; providing an energy recovery device hydraulic line; providing a first booster pump hydraulic line; and providing a second booster pump hydraulic line.

### FIELD OF THE INVENTION

This invention relates to systems for seawater desalination, and particularly to such systems using reverse osmosis (RO).

### BACKGROUND OF THE INVENTION

There is known a process of reverse osmosis (RO) for seawater desalination, which ends in the production of product (permeate) and brine (concentrate) from the seawater, and in which high pressure pumps are used for the supply of the seawater to the system. Typically, the largest component of the operating cost of such process is the power required to drive the high-pressure pumps. Most of the pressure energy of the feed water flowing to the RO membranes leaves the membranes with the brine reject water. A number of devices have been developed to recover pressure energy from the brine reject stream. One example of such devices is isobaric energy recovery device (ERD), which receives the concentrate stream and fresh seawater in the same chambers and equalizes the pressure therebetween. Such a device usually increases the capacity and the maximum operating efficiency of the desalination systems.

### SUMMARY OF THE INVENTION

According to one aspect of the present invention, there is provided a method for improving performance of an original reverse osmosis system for seawater (SW) desalination, said original system comprising:

a high pressure (HP) pump having a pump input for receiving therein a SW supply having a SW flow rate Q_{W}, and a pump output for discharging therefrom said SW supply, said pump being operatable by a motor and to a turbine having a turbine brine input for receiving therein a brine having a brine flow rate Q_{B} and a turbine brine output for discharging therefrom said brine; said motor having a normal operation power P_{MOTOR} at which the pump used to be operated before the performance of the system is improved, and a maximal operation power higher than the normal operation power P_{MAX}; a reverse osmosis (RO) membrane arrangement having a RO SW input for receiving therein said SW supply, a RO permeate output for discharging therefrom a permeate having a permeate flow rate Q_{P}, and a RO brine output for discharging therefrom said brine so that Q_{W}=Q_{B}+Q_{P};

a pump hydraulic line for providing fluid communication between said pump output and said RO SW input; and

a turbine hydraulic line for providing fluid communication between said RO brine output and said turbine brine input;

the method comprising:

operating the motor at a power P_{MOTOR}′, wherein P_{MOTOR}′<P_{MOTOR}′≦P_{MAX};

providing an energy recovery device (ERD) comprising an ERD brine input, an ERD brine output, an ERD SW input, and an ERD SW output;

splitting new brine flow discharged from said RO brine output to a first brine flow to be received in said ERD brine input and to be discharged from said ERD brine output, and a second brine flow to be received in said turbine brine input and to be discharged from said turbine drain output, said first brine flow having a first brine flow rate Q_{B1} and said second brine flow having a second brine flow rate Q_{B2} being lower than said brine flow rate Q_{B};

supplying an additional SW supply to be received in said ERD SW input and to be discharged from said ERD SW output, said supply having a supply flow rate Q_{ADD} substantially equal to said first brine flow rate Q_{B1};

providing a booster pump having a booster pump input for receiving therein said first brine and a booster pump output for discharging therefrom said first brine;

providing a ERD hydraulic line for fluid communication between said turbine hydraulic line and said ERD brine input;

providing a first booster pump hydraulic line for fluid communication between said ERD brine output and said booster pump input; and

providing a second booster pump hydraulic line for fluid communication between said booster pump brine output and said pump hydraulic line.

The above method may further comprise adding to said RO arrangement new membranes for supplying thereto SW having a flow rate at least equal to Q_{ADD}. Alternatively, an additional RO arrangement may be added to said system for supplying thereto SW having a flow rate at least equal to Q_{ADD}.

The method may further comprise producing a new permeate discharged from said RO permeate output, said new permeate having a new permeate flow rate Q_{P}′ at least equal to said permeate flow rate Q_{P}.

In accordance to another aspect of the present invention, there is provided a RO energy recovery system obtained by the method of the present invention from the original RO system, as described above.

### BRIEF DESCRIPTION OF THE DRAWINGS

In order to understand the invention and to see how it may be carried out in practice, embodiments will now be described, by way of non-limiting examples only, with reference to the accompanying drawings, in which:

FIG. 1 illustrates schematically a conventional RO system for seawater (SW) desalination;

FIGS. 2A and 2B illustrate schematically two examples of RO energy recovery system for seawater desalination, designed according to a method of the present invention; and

FIG. 3 is a block diagram illustrating the order of the determination of parameters of the systems shown in FIGS. 2A and 2B.

### DETAILED DESCRIPTION OF EMBODIMENTS

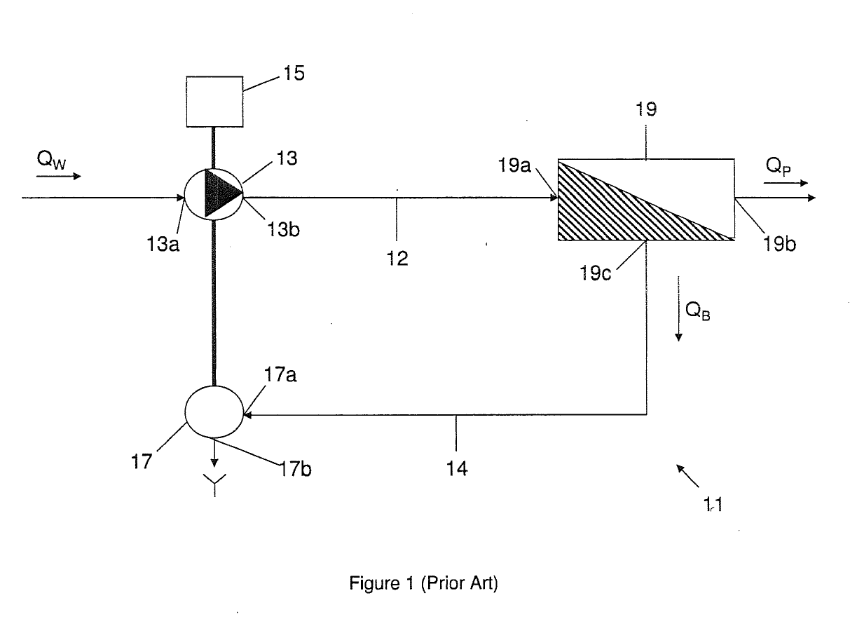

FIG. 1 illustrates schematically a conventional RO system 11 for seawater (SW) desalination, which will further be referred to as original system 11, and it will be explained how in accordance with the present invention, this system may be modified to improve its performance.

The system 11 comprises a high-pressure (HP) pump 13 having a pump input 13a and a pump output 13b, a motor 15, a turbine 17, such as, for example, a Pelton turbine, having a turbine input 17a and a turbine drain output 17b, and a RO membrane arrangement 19 having a RO input 19a, a RO permeate output 19b and a RO brine output 19c. The system 11 further comprises hydraulic lines, namely, a pump hydraulic line 12 providing a fluid communication between the pump output 13b and the RO input 19a, and a turbine hydraulic line 14 providing a fluid communication between the RO brine output 19c and the turbine input 17a.

In operation, SW having a SW flow rate Q_{W} is supplied to the pump input 13a, pressurized by the pump 13 and supplied to the RO arrangement 19 via the hydraulic line 12, where it undergoes RO desalination process, which is known per se, does not constitute a subject of the present invention and will therefore not be described in detail herein. The desalinated water, referred to as permeate P, having a permeate flow rate Q_{P} is discharged from the RO permeate output 19b. The concentrated salt water, referred to as brine B, having a brine flow rate Q_{B}, is discharged from the RO brine input 19c, supplied to the turbine 17 via the hydraulic line 14 and discharged therefrom, with a reduced pressure, through the turbine drain output 17b. The above mentioned flow rates satisfy the following condition: Q_{W}=Q_{P}+Q_{B}.

The motor 15 is adapted to be operated at predetermined range of power lower than a maximal, top power P_{MAX}, at which the motor is capable, but not planned, to be operated. The predetermined range includes a normal power, so that P_{MOTOR}=P_{NORM}, and a start power, so that P_{MOTOR}=P_{START}, satisfying the following condition: P_{NORM}<P_{START}<P_{MAX}, as will be explained in more detail below.

When the system 11 is already in operation, a power for the pump operation P_{PUMP} is combined of the motor power P_{MOTOR} and the turbine power P_{TURBINE}, so that P_{PUMP}=P_{MOTOR}+P_{TURBINE}. The contribution of the turbine 17 depends on the flow rate of the brine supplied thereto. In this condition P_{MOTOR}=P_{NORM}.

When the system is at its start condition, the turbine 17 is still out of operation, as no brine has yet been supplied thereto. The motor 15 is then responsible for supplying all the power required by the pump 13. Therefore, the motor is operated at its start power P_{START}, so that P_{MOTOR}=P_{START}.

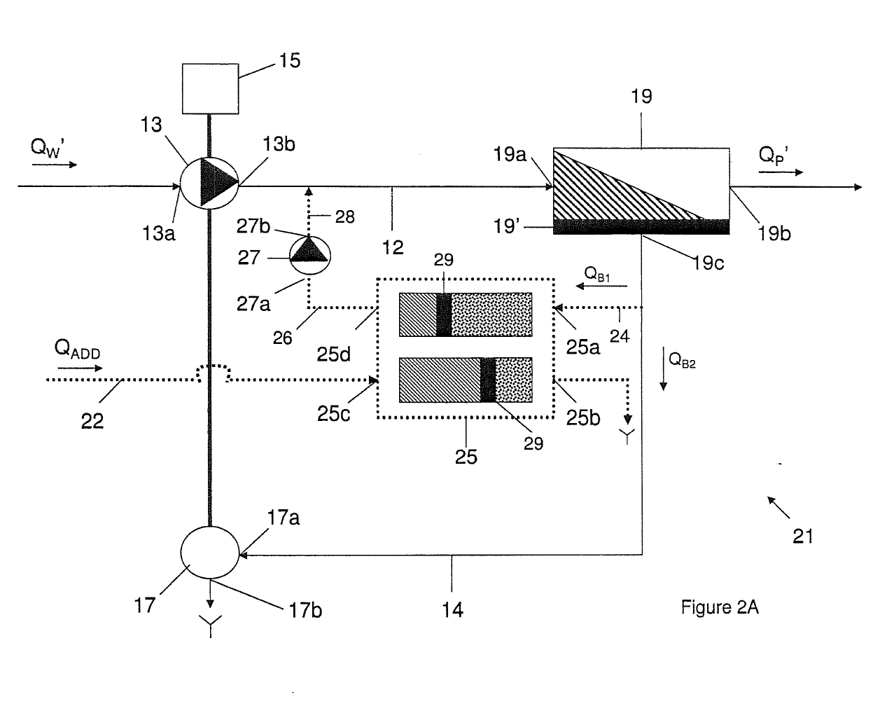

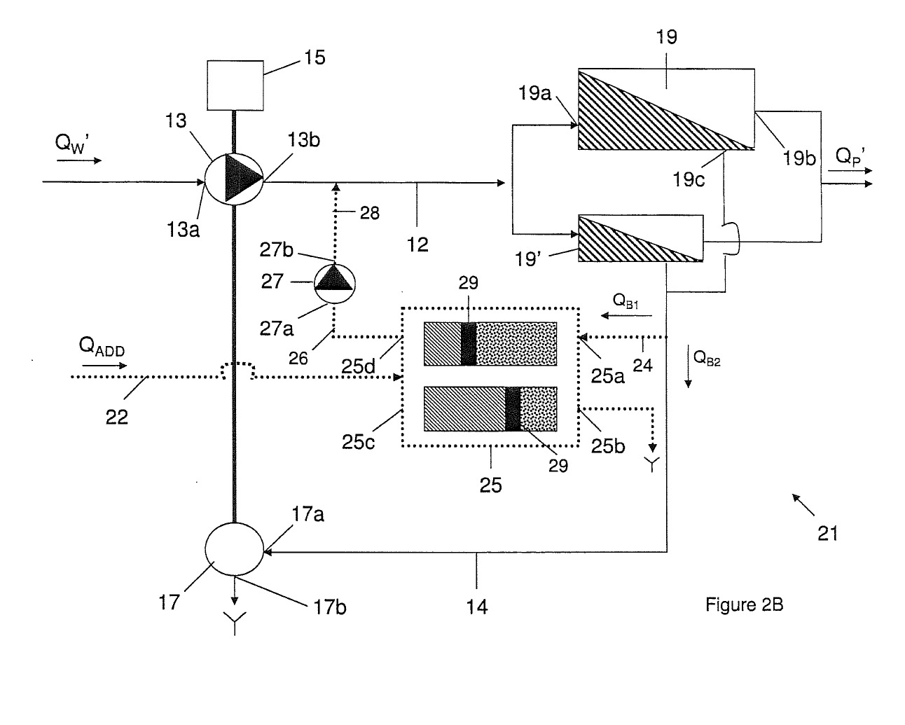

FIG. 2A illustrates schematically an example of RO energy recovery system 21 for seawater desalination, designed according to the present invention as a modification of the original RO system 11, and it will thus be further referred to as modified system 21.

The modified system 21 comprises components of the original system 11 described above, namely, the pump 13, the motor 15, the turbine 17, the RO arrangement 19 and the hydraulic lines 12 and 14.

In addition, the modified system 21 comprises an isobaric energy recovery device ERD 25 having an ERD brine input 25a, and ERD brine output 25b, an ERD SW input 25c and an ERD SW output 25d, a booster pump 27 having a booster pump input 27a and a booster pump output 27b, addition to the RO arrangement 19′ and four additional hydraulic lines 22, 24, 26 and 28. The line 22 is an additional SW hydraulic line for supplying to the system via the ERD additional SW (ASW), as will be further described in detail. The line 24 is an ERD hydraulic line, providing a fluid communication between the turbine hydraulic line 14 and the ERD brine input 25a. The line 26 is booster pump first hydraulic line providing a fluid communication between the ERD SW output 25d and the booster pump input 27a. The line 28 is a booster pump second hydraulic line providing a fluid communication between the booster pump output 27b and the pump hydraulic line 12.

In operation, SW having a SW flow rate Q_{W}′ is supplied to the pump input 13a, pressurized by the pump 13 and then supplied to the RO arrangement 19 via the hydraulic line 12, where it undergoes desalination process, as in the original system. A permeate P having a flow rate Q_{P}′, is discharged from the RO permeate output 19b. A brine B, having a flow rate Q_{B}′ is discharged from the RO brine output 19c and split to a first brine having a flow rate Q_{B1} and a second brine having a flow rate Q_{B2}. The first brine is supplied to the ERD via the hydraulic line 24 and discharged therefrom through the ERD brine output 25a. The second brine is supplied to the turbine 17 via the turbine hydraulic line 14 and discharged therefrom through the turbine drain output 17b. The ASW having a flow rate Q_{ADD} is supplied to the ERD via the hydraulic line 22 and then discharged therefrom via the hydraulic line 26, pressurized by the booster pump 27 and supplied to the pump hydraulic line 12 via the hydraulic line 28 to be mixed with the fresh SW.

The ERD equalizes the pressures between the first brine and the ASW. In particular, the ERD receives the high-pressure brine and the low-pressure SW and by means of a piston 29 transfers the pressure from the brine to the SW, which is described in the Background of the Invention and is known per se. Therefore, due to the mass balance, the flow rate of the first brine Q_{B1} supplied to the ERD and the flow rate Q_{ADD} of the ASW are substantially equal.

The booster pump 27 is a HP suction pump that compensates to the pump hydraulic line 12, pressure losses occurred in the RO arrangement 19 and the ERD 25, compared with the original pressure at the RO input 19a.

The addition 19′ to the RO arrangement 19 is required since the flow through the RO arrangement 19 has been increased relative to that in the original system. The filtering capacity of this addition should be sufficient to provide the filtration of sea water having flow rate of at least Q_{ADD}.

The expansion of the RO arrangement by the addition 19′ may be achieved by adding new membranes to the existing RO arrangement, as shown in FIG. 2A or by adding another RO arrangement to the system, as shown in FIG. 2B. In the latter case, additional hydraulic lines may be provided

The design of the modified system 21 was based on the following considerations and conditions. The first condition is an increase in the amount of permeate, so that Q_{P}′>Q_{P}. The second condition is a decrease in the power contributed by the turbine 17 to the motor 15, so that P_{TURBINE}>P_{TURBINE}′. As mentioned above, the power contributed by the turbine depends on the brine flow supplied thereto. Therefore, the brine flow through the turbine 17 in the modified system 21 has to be reduced with respect to the brine flow through the turbine 17 in the original system 11, so that Q_{B2}<Q_{B}. In the modified system 21 the motor 15 has to compensate the power previously contributed by the turbine, so as to enable the pump 13 to operate in the same way as in the original system 11. Consequently, the operation power P_{MOTOR} of the motor 15 has to be increased, so that P_{MOTOR}′>P_{MOTOR}.

The modification method thus comprised the following two main steps:
(a) adding new components to the original system 11, namely, the ERD 25, the booster pump 27, the addition 19′ to the RO arrangement 19 and the hydraulic lines 22, 24, 26 and 28; and
(b) determining and calculating the following parameters of the modified system 21: powers P_{MOTOR}′, P_{PUMP}′, and P_{TURBINE}′ and the flow rates Q_{W}′, Q_{P}′, Q_{B1}, Q_{B2} and Q_{ADD}.

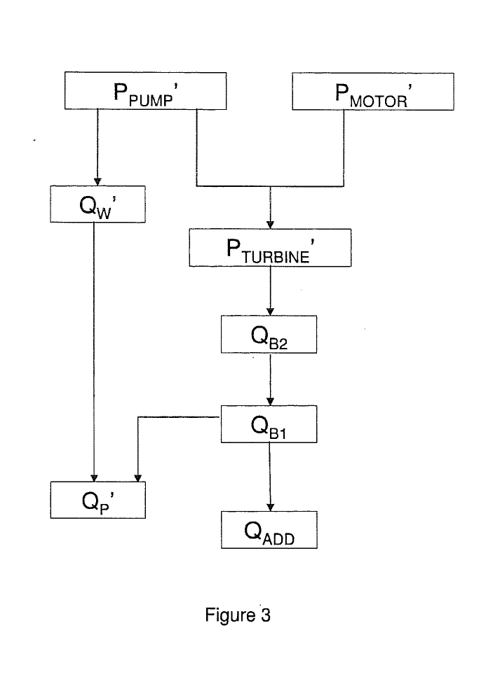

Reference is made to FIG. 3, which is a block diagram describing the parameters determination. P_{PUMP}′ normally equals P_{PUMP}, since the pump 13 remains the same as in the original system 11. Therefore, the flow rate therethrough will also remain substantially the same as in the original system 11, i.e. Q_{W}′=Q_{W}. P_{MOTOR} is increased so that P_{MOTOR}′>P_{MOTOR} and satisfies the following condition: P_{NORM}<P_{MOTOR}′≦P_{MAX}. Normally, P_{MOTOR}′ will not be higher than P_{START}.

Once P_{PUMP}′ and P_{MOTOR}′ are determined, P_{TURBINE}′ is calculated from P_{TURBINE}′=P_{PUMP}′−P_{MOTOR}′. P_{TURBINE}′ depends on the flow of the brine therethrough. Therefore, Q_{B2} and then Q_{B1} are determined.

The capacity of the ERD is determined based on the flow supplied thereto. Therefore, once Q_{B1} is calculated, Q_{ADD} is defined to be substantially equal thereto and ERD device is chosen to fit the above flow rates.

Based on the above rates Q_{P}′ is calculated, based on which the size of the addition 19′ to the RO arrangement 19 is determined.

The modified system 21 has improved performance relative to the original system 11. First, the amount of permeate is increased, so that Q_{P}′>Q_{P}. Second, the efficiency of the system is improved. The reason for that is that, since the turbine 17 has low efficiency relatively to the other components of the system, and the flow therethough suffers from high energy losses, the lower the flow therethrough, the lower the losses. In the modified system the brine flow through the turbine is decreased since Q_{B2}<Q_{B}. Consequently, the energy losses caused by the turbine 17 are decreased. At the same time, part of the flow, i.e. the second brine with the flow rate Q_{B1} is supplied to the ERD 25, which is more efficient than the turbine 17.

It should be noted that all the above is achieved only by adding two new components to the original system, i.e. the ERD and the RO addition 19′, and some some hydraulic lines, without the need of replacement of any the exciting components of the original system 11.

### Example

In the original system 11:

Pump power requirement is calculated as follows:

$${P}_{PUMP} = \frac{{Q}_{W} \cdot {TDH}_{PUMP}}{36 \cdot {E}_{PUMP}}$$

where TDH_{PUMP} is total dynamic head of the pump, and E_{PUMP} is the pump efficiency.

Values of the above parameters used in the present example are:

$${Q}_{W} = 800 \frac{{m}^{3}}{h}$$

$${TDH}_{PUMP} = 65 BARG$$

$${E}_{PUMP} = 84 \%$$

$${P}_{PUMP} = \frac{800 \cdot 65}{36 \cdot 0.84} = 1719.6 kW$$

Power supplied by the turbine is calculated as follows:

$${P}_{TURBINE} = \frac{{Q}_{B} \cdot {TDH}_{TURBINE}}{36} \cdot {E}_{TURBINE}$$

$${Q}_{B} = {Q}_{W} - {Q}_{P}$$

where TDH_{TURBINE} is total dynamic head of the turbine, and E_{TURBINE} is the turbine efficiency.

Values of the above parameters are:

$${Q}_{P} = 0.48 {Q}_{W} = 384 \frac{{m}^{3}}{h} ⇒ {Q}_{B} = 800 - 384 = 416 \frac{{m}^{3}}{h}$$

$${TDH}_{TURBINE} = 70 BARG$$

$${E}_{TURBINE} = 87 \%$$

$${P}_{TURBINE} = \frac{416 \cdot 70}{36} \cdot 0.87 = 703.7 kW$$

Power supplied by the motor is calculated as follows:

P_{MOTOR}=P_{PUMP}−P_{TURBINE}1719.6−703.7=1015.9 kW

In the modified system 21:

P_{PUMP}=P_{PUMP}′

Power supplied by the motor is:

P_{MOTOR}=1300 kW

Power supplied by the turbine is:

P_{TURBINE}=P_{PUMP}−P_{MOTOR}=1719.6−1300=419.6 kW

Brine flow rate through the turbine is:

$${Q}_{B 2} = \frac{{P}_{TURBINE}}{{TDH}_{TURBINE} \cdot {E}_{TURBINE}} \cdot 36 = \frac{419.6}{70 \cdot 0.87} \cdot 36 = 248 \frac{{m}^{3}}{h}$$

Brine flow rate through the ERD is calculated as follows:

$${Q}_{B} + 0.52 {Q}_{ADD} = {Q}_{B 1} + {Q}_{B 2}$$

$${Q}_{ADD} = {Q}_{B 1} \\ ⇒ 416 + 0.52 \cdot {Q}_{B 1} = {Q}_{B 1} + 248 \\ ⇒ {Q}_{B 1} = 350 \frac{{m}^{3}}{h}$$

The permeate flow rate is:

$${Q}_{P}^{′} = {Q}_{P} + 0.52 {Q}_{ADD} = 384 + 0.48 \cdot 350 = 552 \frac{{m}^{3}}{h}$$

The improvements of the modified system 21, as discussed above, are clearly shown in the above example.

$${Q}_{P} = 384 \frac{{m}^{3}}{h} and {Q}_{P} = 552 \frac{{m}^{3}}{h} ,$$

therefore, Q_{P}′>Q_{P}. In addition, the brine flow through the turbine 17 in the modified system 21

$$( {Q}_{B 2} = 248 \frac{{m}^{3}}{h} ) ,$$

is lower than the brine flow through the turbine 17 in the original system 11

$$( {Q}_{B} = 416 \frac{{m}^{3}}{h} ) .$$

Therefore, less power is contributed by the turbine (P_{TURBINE}′<P_{TURBINE}) and less energy losses are caused.

Those skilled in the art to which this invention pertains will readily appreciate that numerous changes, variations, and modifications can be made without departing from the scope of the invention.

1-5. (canceled)

6. A reverse osmosis (RO) system comprising:
at least one RO unit arranged to extract product water from gauge pressurized sea water received from a high pressure pump, thereby rejecting gauge pressurized brine;
a Pelton turbine arranged to transfer to the high pressure pump torque that is generated from the rejected brine;
a pressure exchanger arranged to transfer gauge pressure of a part of the rejected brine into gauge pressure of received sea water; and
a booster pump arranged to deliver the gauge pressurized sea water from the pressure exchanger to the RO unit.

7. The RO system of claim 6, wherein the at least one RO unit comprises one RO unit.

8. The RO system of claim 6, wherein the at least one RO unit comprises two RO units arranged to jointly receive the gauge pressurized sea water from the high pressure pump and from the booster pump, and wherein the rejected gauge pressurized brine comprises brine rejected from both RO units.

9. The RO system of claim 8, wherein the gauge pressure transfer by the pressure exchanger is configured to allow operating two RO units instead of one RO unit on the same high pressure pump and Pelton turbine.

10. A method comprising:
transferring gauge pressure from a part of a rejected brine to received sea water, wherein the rejected brine is generated by at least one RO unit and is used to transfer torque via a Pelton turbine to a high pressure pump that provides gauge pressurized sea water to the at least one RO unit, and
delivering the gauge pressurized sea water from said transferring to the at least one RO unit, to increase energy recovery from the rejected brine while retaining a power consumption of the high pressure pump.

11. The method of claim 10, wherein the transferring of gauge pressure from the part of the rejected brine to the received sea water is carried out by a pressure exchanger, and wherein the delivering of the gauge pressurized seawater to the at least one RO unit is carried out by a booster pump.

12. The method of claim 10, further comprising
delivering gauge pressurized sea water from both the high pressure pump and the booster pump to two RO units, and
receiving the rejected brine from both RO units,
wherein the received rejected brine is delivered to the Pelton turbine and to the pressure exchanger for gauge pressurizing sea water.

13. The method of claim 12, wherein the part of the rejected brine from the two RO units, that is delivered to the pressure exchanger, is selected according to power limitations of the high pressure pump.
